(19) United States
(12) Patent Application Publication
(10) Pub. No.: US 2022/0266468 A1
(43) Pub. Date: Aug. 25, 2022

(54) CUTTER ASSEMBLY AND CUTTING MACHINE USING THE SAME

(71) Applicant: KING YUAN FU PACKAGING CO., LTD., New Taipei City (TW)

(72) Inventor: YU-HUI CHEN, NEW TAIPEI CITY (TW)

(21) Appl. No.: 17/242,011

(22) Filed: Apr. 27, 2021

(30) Foreign Application Priority Data
Feb. 22, 2021 (TW) 110201935

(51) Int. Cl. B26F 1/14

(52) U.S. Cl. CPC B26F 1/14

(57) ABSTRACT

The present disclosure is a cutter assembly, which mainly includes a carrier and a plurality of cutters, wherein the cutters are disposed on the carrier. Each of the cutters includes a blade and a cutter seat. The cutter seat has at least one upper-adjusting hole and at least one lower-adjusting hole, wherein the upper-offset hole is formed with a diameter greater than that of the lower-adjusting hole, and the upper-adjusting hole and the lower-adjusting hole form a countersink surface therebetween. At least one first fastener passes through the upper-adjusting hole and the lower-adjusting hole and engages with the carrier. The first fastener has a top portion formed with a diameter greater than the lower-adjusting hole and less than the upper-adjusting hole, the top portion of the first portion does not press against the countersink surface between the upper-adjusting hole and the lower-adjusting hole.

### CROSS-REFERENCE TO RELATED APPLICATIONS

This non-provisional application claims priority claim under 35 U.S.C. § 119(a) on Taiwan Patent Application No. 110201935 filed on Feb. 22, 2021, the entire contents of which are incorporated herein by reference.

### TECHNICAL FIELD

The present disclosure relates to a cutter assembly and cutting machine using the same, which is particularly adapted to cut a shrunken or deformed material.

### BACKGROUND

Generally, a cutter assembly for cutting materials such as leather, fibre, cloth fabric, or etc., which has a plurality of cutters to perform mass cutting process in once. First referring to FIG. 1A and FIG. 1B, which are a top view and side view of a conventional cutter assembly 1. The cutter assembly 1 includes a carrier 11 and a cutting unit 12. The cutting unit 12 includes a plurality of cutters 121, a mounter 122 and a metal plate 123. The carrier 11 and the mounter 122 may be such as wooden plates, wherein the mounter 122 is formed with at least one socket via laser cutting, and the metal plate 123 is positioned between the carrier 11 and the mounter 122. The cutters 121 are made of steel or other suitable material, formed as a round-rectangular frame as shown in FIG. 1A, and plugged into the socket(s) of the mounter 122 thereby to fasten the entire cutting unit 12 on the mounter 122.

The cutters 121 of the cutting unit 12 on the conventional cutter assembly 1, which are fixed, and unable to adjust a relative position and a distance therebetween, not even unturnable. When the cutters 121 are required to move and adjust the distance therebetween or even direction angles thereof, there is no choice but to redesign and produce another cutter assembly, therefore causing inconvenience and cost therewith. To be brief, the conventional cutter assembly 1 is lack of configurability, therefore there is a need of a more convenient, configurable cutter assembly, to overcome such technical drawback of repeated redesigns and productions also the cost therewith.

### SUMMARY

To solve the problem of the conventional technology, the present disclosure provides a more configurable cutter assembly, which includes cutters that are slightly movable according to a size of material during a cutting process, therefore to facilitate cutting and dicing a shrunken or deformed material and overcome the aforementioned technical drawback.

An object of the present disclosure is to provide a cutter assembly, which mainly includes a carrier and a plurality of cutters, wherein the cutters are connected to the carrier via at least one first fastener. The first fastener has a diameter less than that of an adjusting hole on the cutter. The first fastener does not press against the cutters, thereby to allow the cutters slightly movable or turnable.

When cutting a material via the cutter assembly according to the present disclosure, the cutters can be guided by concave markers on the material and then move and turn relative to the carrier, such that to accurately cut along the markers and produce cut pieces with a constant, uniform size and shape.

An object of the present disclosure is to provide a cutter assembly, wherein the cutters disposed on the carrier are self-adjustable according to a distance of the markers and cut the material from a preset position.

The present disclosure provides a cutter assembly, which includes: a carrier having a plurality of first holes; at least one cutter including a blade and a cutter seat wherein the blade is connected to and protrudes upward from the cutter seat, the cutter seat has at least one upper-adjusting hole and at least one lower-adjusting hole, the upper-adjusting hole and the lower-adjusting hole together extend through the cutter seat and have a spatial communication therebetween, the upper-adjusting hole is formed with a diameter greater than that of the lower-adjusting hole, thereby the cutter seat is formed with a countersink surface between the upper-adjusting hole and the lower-adjusting hole; at least one first fastener having a top portion and a fastening portion, wherein the fastening portion is connected to the top portion; and a countersink member is connected to the first fastener wherein the countersink member and the top portion respectively have a diameter less than that of the upper-adjusting hole, the countersink member has a diameter greater than that of the lower-adjusting hole, the fastening portion has a diameter less than that of the lower-adjusting hole, the first fastener passes through the upper-adjusting hole and the lower-adjusting hole and engages with the first hole to fasten the cutters on the carrier, wherein the countersink member and the countersink surface of the cutter have a gap therebetween, thereby the cutters slightly move or turn during the cutting process.

The present disclosure provides a cutter assembly, which includes: a carrier having a plurality of first holes; at least one cutter including a blade and a cutter seat wherein the blade is connected to and protrudes upward from the cutter seat, the cutter seat has at least one upper-adjusting hole and at least one lower-adjusting hole, the upper-adjusting hole and the lower-adjusting hole together extend through the cutter seat and have a spatial communication therebetween, the upper-adjusting hole is formed with a diameter greater than that of the lower-adjusting hole, thereby the cutter seat is formed with a countersink surface between the upper-adjusting hole and the lower-adjusting hole; and at least one first fastener having a top portion and a fastening portion, wherein the fastening portion is connected to the top portion, the top portion respectively have a diameter less than that of the upper-adjusting hole, the top portion has a diameter greater than that of the lower-adjusting hole, the fastening portion has a diameter less than that of the lower-adjusting hole, the first fastener passes through the upper-adjusting hole and the lower-adjusting hole and engaged with the first hole to fasten the cutters on the carrier, wherein the top portion and the countersink surface of the cutter have a gap therebetween, thereby the cutters are slightly movable or turnable during the cutting process.

In one embodiment of the cutter assembly according to the present disclosure, the cutter assembly further includes at least one second fastener. The carrier further includes at least one second hole. The cutter seat further has at least one fastening hole disposed on a lower surface thereof, and the second fastener passes the second hole and engages with the fastening hole.

In one embodiment of the cutter assembly according to the present disclosure, the cutter assembly further includes at least one lateral fastener. The cutter seat further has at least one tightening hole disposed on a lateral surface thereof. The lateral fastener passes through a through hole of the cutter and engages with the tightening hole, thereby to fasten the cutter on the cutter seat.

In one embodiment of the cutter assembly according to the present disclosure, the first fastener is a bolt, the countersink member is a gasket, the first fastener passes through a through hole of the gasket and engages with the first hole of the carrier.

In one embodiment of the cutter assembly according to the present disclosure, the carrier is made of wood, the cutter is made of stainless steel, and the blade is formed in a round-rectangular shape.

In one embodiment, the present disclosure provides a cutting machine, which includes the aforementioned cutter assembly, and a main console for mounting the cutter assembly.

To be brief, in this embodiment, the cutters of the cutter assembly are slightly movable or turnable relative to the carrier, therefore the cutter assembly is relatively configurable, adjustable and capable of overcoming the aforementioned technical drawback.

### BRIEF DESCRIPTION OF THE DRAWINGS

The structure as well as preferred modes of use, further objects, and advantages of this present disclosure will be best understood by referring to the following detailed description of some illustrative embodiments in conjunction with the accompanying drawings, in which:

FIG. 1A is a top view of a conventional cutter assembly.

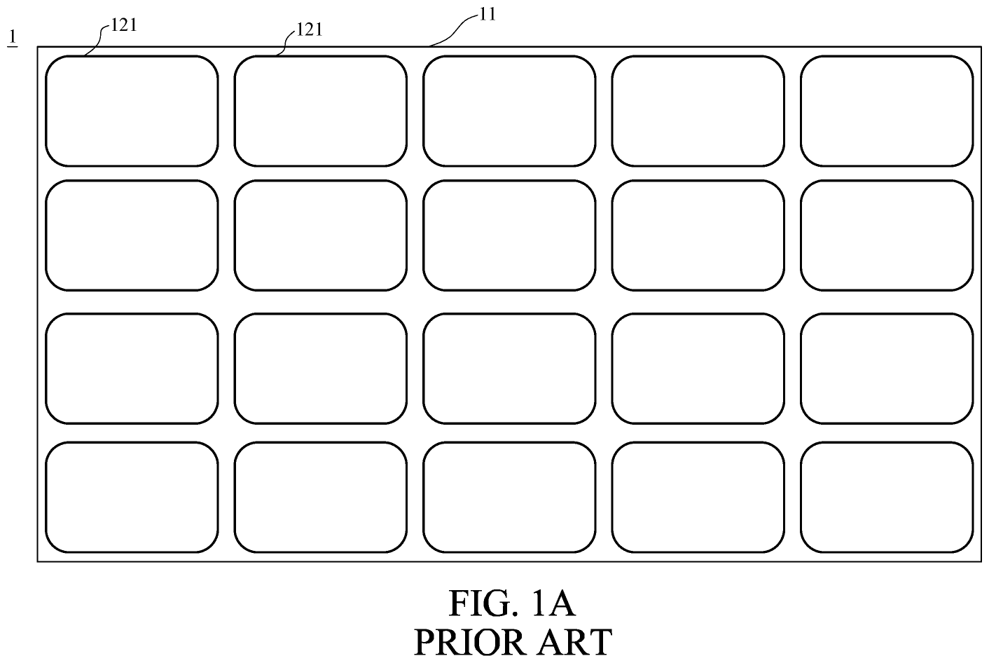

FIG. 1B is a side view of the conventional cutter assembly.

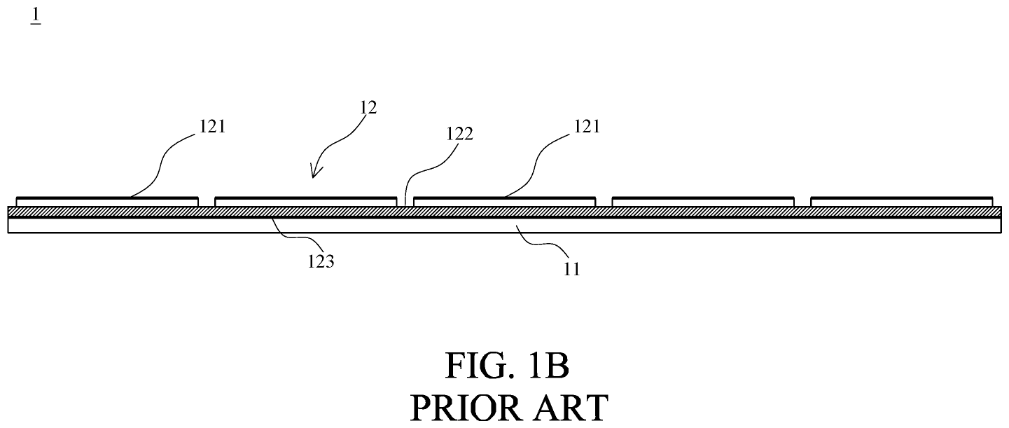

FIG. 2A is top view of a cutter assembly according to the present disclosure.

FIG. 2B is sectional view of the cutter assembly according to the present disclosure.

FIG. 3A is top view of cutters of the cutter assembly according to the present disclosure.

FIG. 3B is bottom view of the cutters of the cutter assembly according to the present disclosure.

FIG. 3C is sectional view of the cutters of the cutter assembly according to the present disclosure.

FIG. 3D is fragmentary sectional view of cutters of the cutter assembly according to the present disclosure.

### DETAILED DESCRIPTION OF THE PREFERRED EMBODIMENTS

To clearly understand the objects of the present disclosure, herein to describe and explain details of the present disclosure by following embodiment(s) with the attached drawings.

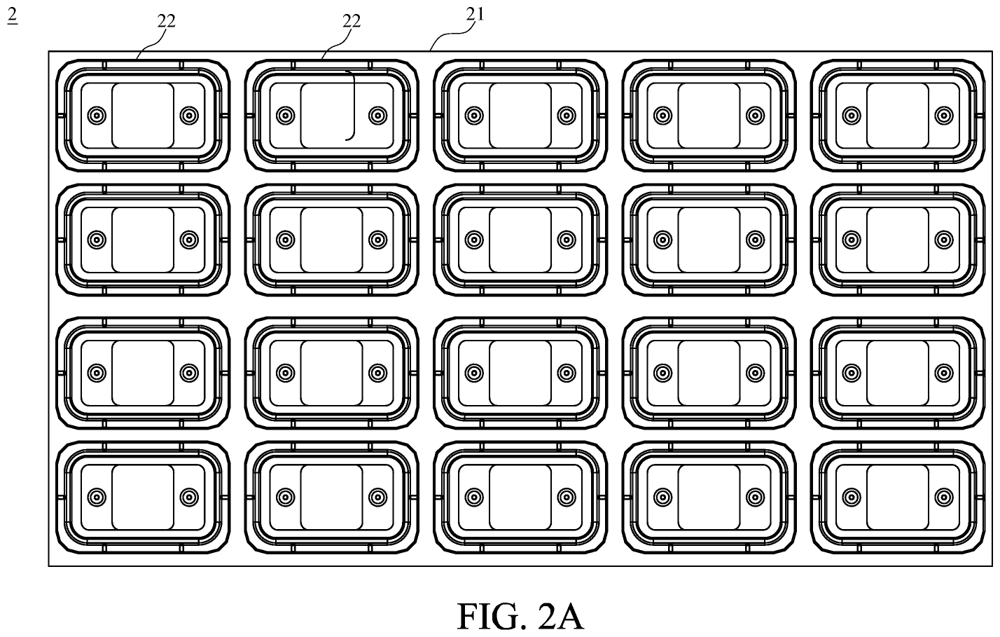

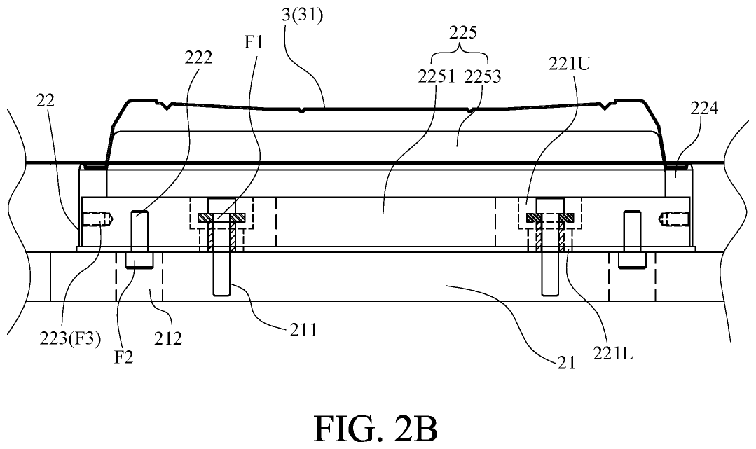

Referring to FIG. 2A, the present disclosure in this embodiment provides a cutter assembly 2, which is featured in having cutters 22 slightly movable relative to a carrier 21, according to a shape or size of a material 3 during a cutting process. Thereby the cutter assembly 2 is particularly adapted in cutting materials those may shrink or deform, such as leather.

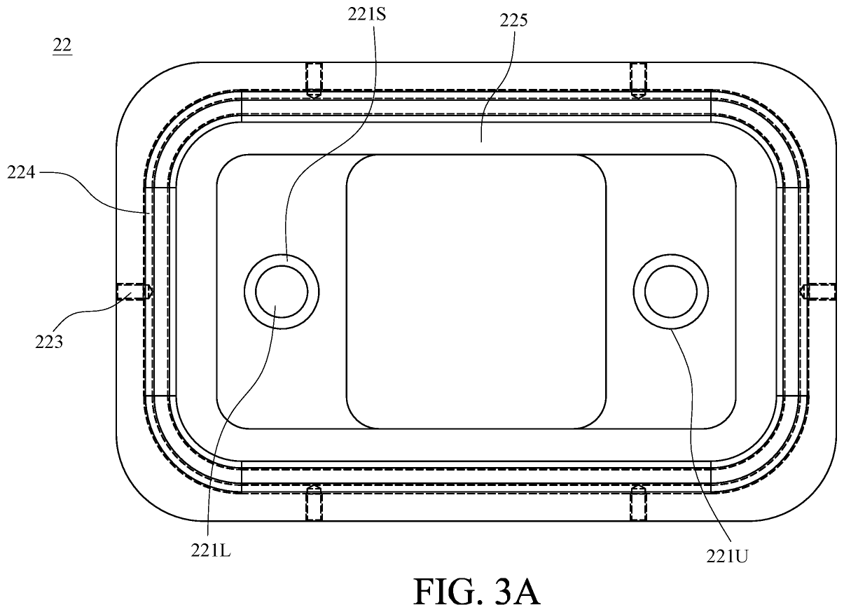

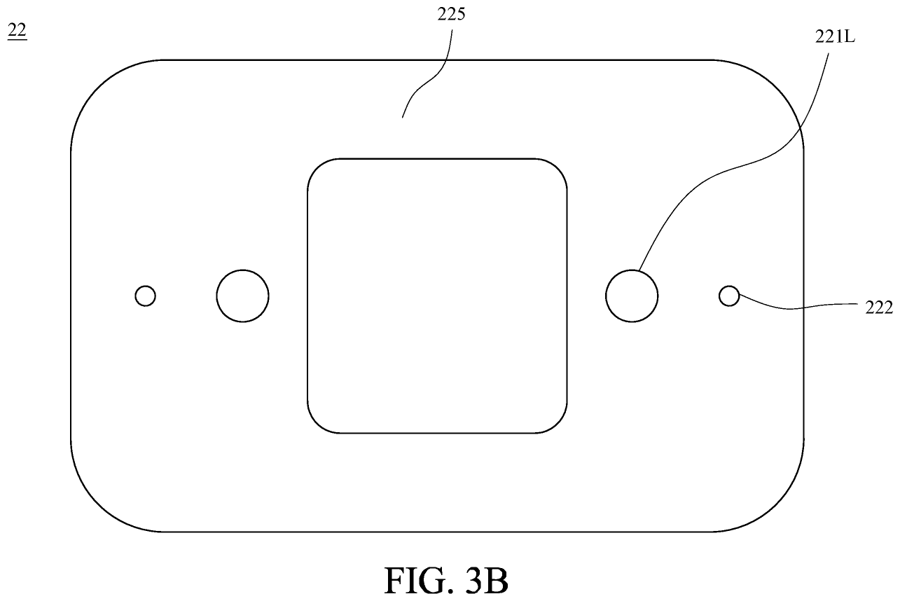

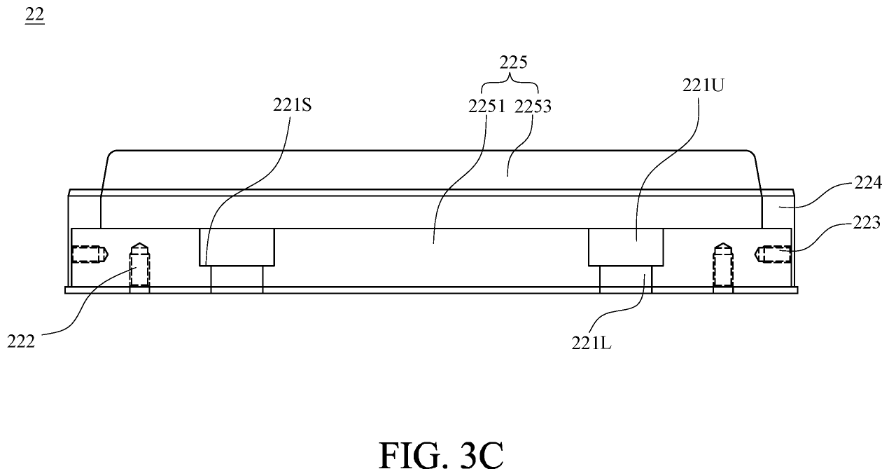

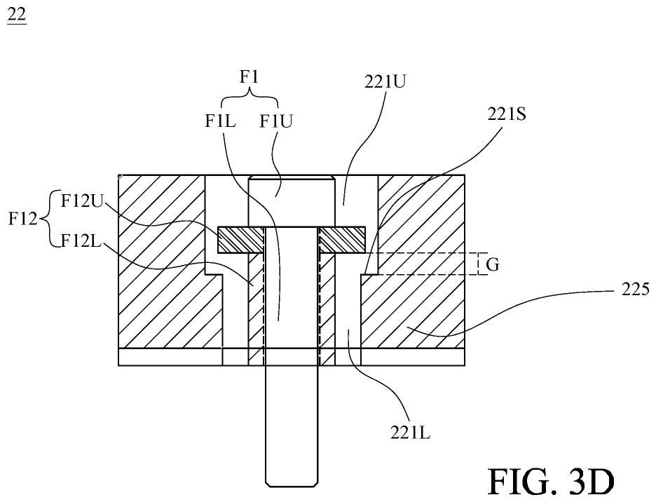

Referring to FIG. 2A-FIG. 3D, wherein FIG. 2A and FIG. 2B are respectively a top view and a bottom view of the cutter assembly 2 according to the present disclosure, and FIG. 3A-FIG. 3D are respectively a top view, bottom view, sectional view and a fragmentary sectional view of the cutter assembly 2 according to the present disclosure. The cutter assembly 2 includes a carrier 21 and at least one cutter 22 (plural in this embodiment). As shown in FIG. 2B, the carrier 21 has a plurality of first holes 211 and/or a plurality of second holes 212. Each two of the first holes 211 and each two of second holes 212 are set as a group and disposed correspondingly to the cutter(s) 22, the groups of first holes 211 and second holes 212 are arrayed in a matrix manner. The carrier 21 may be a plate made of such as wood or other suitable materials, but not limited thereto. Additionally, in other embodiment, it may be one of the first holes 211 and one of the second holes 212 set as a group, therefore number of the first holes 211 and the second holes 212 in a group is not limited by the aforementioned embodiment.

As shown FIG. 2B, a plurality of first fasteners F1 may sequentially pass through upper-adjusting holes 221U and lower-adjusting holes 221L on the cutter(s) 22, then to engage with the first holes 211 on the carrier 21, and fasten the cutter(s) 22 on the carrier 21. In one embodiment of the present disclosure, a plurality of second fasteners F2 may further pass through the second holes 212 on the carrier 21, and then engage with fastening holes 222 on a cutter seat 225, such that to fasten the cutter(s) 22 on the carrier 21. However, the second fasteners F2, the second holes 212 and the fastening holes 222 are not necessary elements of the present disclosure, thus claim scope of the present disclosure is not limited thereto. After being fastened, each of the cutters 22 may be applied to cut and dice a material 3 by a blade 224 thereof, and the material 3 may be such as leather, fibre or cloth fabric but not limited thereto.

Specifically, as shown in FIG. 2B-FIG. 3D, the cutter(s) 22 includes the cutter seat 225 and the blade 224, wherein the blade 224 is connected to the cutter seat 225 and protrudes upward. To be more specific, the cutter seat 225 maybe a bulge block, and has at least one tightening hole 223 (plural in this embodiment) in a lateral surface thereof. The blade 224 may be formed as a round-rectangular frame, and be mounted on and surround the cutter seat 225. A lateral fastener F3 is used for passing through a plurality of through holes on the blade 224 and engaging with the tightening hole(s) 223 in lateral side of the cutter seat 225, such that to connect the blade 224 and the cutter seat 225. In one embodiment of the present disclosure, the first fasteners F1, the second fasteners F2 and the lateral fasteners F3 may be bolts or rivets.

In one embodiment of the present disclosure, the cutter seat 225 of the cutter(s) 22 includes a bottom portion 2251 and a protrusion 2253. The protrusion 2253 is connected to the bottom portion 2251, and has a cross section and/or a periphery smaller than the bottom portion 2251, such as an annular flange disposed on a surface of the bottom portion 2251. When the blade 224 is mounted to surround the bottom portion 2251 of the cutter seat 225, the protrusion 2253 may be higher than or further protrude from the blade 224.

Referring to FIG. 3D, the cutter seat 225 of the cutter(s) 22 includes a plurality of upper-adjusting hole 221U, a plurality of lower-adjusting hole 221L and/or a plurality of fastening holes 222, wherein the upper-adjusting holes 221U and the lower-adjusting holes 221L are disposed to correspond to each other. Specifically, the upper-adjusting holes 221U are disposed on an upper surface of the cutter seat 225, and extend downward from the upper surface of the cutter seat 225. The lower-adjusting holes 221L are disposed on a lower surface of the cutter seat 225, and extend upward the lower surface of the cutter seat 225. Each of the upper-adjusting holes 221U and each of the lower-adjusting holes 221L are respectively connected to each other, and have a spatial communication therebetween. Each of the upper-adjusting holes 221U is formed with a diameter greater than that of each of the lower-adjusting holes 221L, thereby each of the upper-adjusting holes 221U and a corresponding one of the lower-adjusting holes 221L together form a countersink surface 221S therebetween within the cutter seat 225.

In one embodiment of the present disclosure, each of the first fasteners F1 includes a top portion HU and a fastening portion F1L, wherein the top portion HU is connected to the fastening portion F1L. The top portion FlU has a diameter greater than that of the fastening portion F1L, the first fasteners F1 may be bolts, rivets or nails, etc. Moreover, the top portion HU of each of the first fasteners F1 has a diameter, which is less than that of each of the upper-adjusting holes 221U on the cutter seat 21, and which is greater than that of each of the lower-adjusting holes 221L the cutter seat 21. The fastening portion F1L of each of the first fasteners F1 has a diameter less than that of each of the upper-adjusting holes 221U and the lower-adjusting holes 221L on the cutter seat 225.

The first fasteners F1 may pass through the corresponding upper-adjusting holes 221U and lower-adjusting holes 221L of carrier 21, and engage with the correspondingly first holes 211 thereof to fasten the cutters 22 on the carrier 21. As the upper-adjusting holes 221U are formed with diameters greater than those of the lower-adjusting holes 221L, and as the top portions F1U of the first fasteners F1 have diameters greater than those of the lower-adjusting holes 221L, the cutter(s) 22 can be retained between the top portions F1U of the first fasteners F1 and the carrier 21. Also, the top portion F1U of each of the first fasteners F1 and a corresponding one of the countersink surfaces 221S in the cutter seat 225 has a gap G therebetween.

In one embodiment of the present disclosure, each one of the first fasteners F1 may be connected to the cutter seats 225 and/or the carrier 21, via a countersink member F12. A diameter of each of the countersink members F12 and the diameter of each of the first fasteners F1, which are less than that of each of the upper-adjusting holes 221U on the cutter seat 225, and which are greater than that of each of the lower-adjusting holes 221L on cutter seat 225, such that to retain the cutter(s) 22 between the countersink members F12 and the carrier 21. Each of the countersink members F12 may be gaskets, and has a through hole allowing a corresponding one of the first fasteners F1 to pass through and engage with a corresponding one of the first holes 211 on the carrier 21. With the countersink members F12, the top portions F1U of the first fasteners F1 may have their diameters less than those of the lower-adjusting holes 221L on the cutter seat 225.

To be specific, each of the countersink members F12 includes a bottom portion F12L and a top portion F12U, wherein the bottom portion F12L is connected to the top portion F12U. The bottom portion F12L has a diameter which is less than that of the top portion F12U, also which is greater than that of the lower-adjusting holes 221L on the cutter seat 225, and which is less than that of the upper-adjusting holes 221U on the cutter seat 225. Moreover, the bottom portion F12L of each of the countersink members F12 has a height greater than that of each of the lower-adjusting holes 221L on the cutter seat 225. Moreover, when the first fasteners F1 are connected to the carrier 21 via the countersink members F12, the top portion F12U of each of the countersink members F12 and a corresponding one of the countersink surfaces 221S have a gap G therebetween.

The first fasteners F1 and/or the countersink members F12 according to the present disclosure, which do not press against the countersink surfaces 221S formed between the upper-adjusting holes 221U and the lower-adjusting holes 221L, but to keep the gaps G from the countersink surfaces 221S, thereby the cutters 22 are movable relative to the carrier 21, such as to move left, right or slightly turn related to the carrier 21.

To be brief, the first fasteners F1, the upper-adjusting holes 221U and the lower-adjusting holes 221L together form a fastening and adjustable structure, as the cutter(s) 22 is disposed or fastened on the carrier 21 via the fastening and configurable structure, the cutter(s) 22 hence can slightly move and even turn related to the carrier 21.

In practical use, the material 3 may include at least one marker 31, wherein the marker(s) 31 may be a cavity (cavities) disposed, formed on the material 3 via such as thermoforming.

During the cutting process, the cutter(s) 22 can enter the concave marker(s) 31 and dice the material 3 along a contour of the marker(s) 31. As the cutter(s) 22 according the present disclosure is movably fastened on the carrier 21, when the cutter(s) 22 enters the marker(s) 31, the cutter(s) 22 is guided by the contour(s) of marker(s) 31 and moves slightly related to the carrier(s) 21, thereby to dice the material 3 along the contour(s) of the marker(s) 31, then such as the protrusion 2253 of the cutter seat 225 of the cutter(s) 22 moves along the concave marker(s) 31, thereby the cutter(s) 22 and the blade 224 thereof is accurately guided to cut and process the material 3.

Specifically, when the material 3 is made of leather and formed with plurality of the markers 31, which may shrink or deform during the processes, thereby distances between the markers 31 may vary. When cutting the shrunken or deformed material 3 by the conventional cutter assembly 1, as the cutters 121 are fixed in the sockets mounters 122, the cutters 121 cannot dice the material 3 along the markers 31, therefore the cut and processed material 3 may have an unexpected, undesired appearance or shape.

In contrary to the conventional cutter assembly 1, the cutter assembly 2 according to the present disclosure has the cutter(s) 22 slightly movable or turnable relative to the carrier 21 when cutting the material 3, in a manner of such as to move or turn on a surface of the carrier 21. Therefore, even if the material 3 shrinks and causes the distances between the markers 31 to vary, the cutter(s) 22 move related to the carrier 21 and along the contours of the markers 31 to proper position(s), and then to cut and dice the material 3 as preset. Basically, as long as the material 3 is not excessively shrunken or deformed, the cutter assembly 2 according to the present disclosure is adapted to self-adjust the cutters 22 along with the shrinkage or deformation of the material 3, thereby the cut and processed material 3 can have a desired appearance or shape as expected.

Furthermore in one embodiment, the present disclosure also provides a cutting machine, which includes the aforementioned cutter assembly 2 and a main console, wherein the cutter assembly 2 is mounted on the main console for cutting and dicing the material 3. In one embodiment, the main console controls the material 3 to contact the cutter assembly 2 and cut the material 3. Also in another embodiment, the main console may control the cutter assembly 2 to contact and cut the material 3.

In summary, the present disclosure provides a cutter assembly 2, which is configured to have the wide upper-adjusting holes 221U and the narrow lower-adjusting holes 221L and include the countersink members F12 and the first fasteners F1, also each of the first fasteners F1 has the top portion and the fastening portion formed with diameters respectively less than those of each of the wide upper-adjusting holes 221U and each of the narrow lower-adjusting holes 221L, thereby the cutter(s) 22 according to the present disclosure is movable and even turnable relative to the carrier 21 during the process of cutting the shrunken and deformed material 3. Thus, in contrary to the conventional technology, the cutter assembly 2 according to the present disclosure is more configurable and adjustable for overcoming the drawback of repeated redesigns and productions also the cost therewith.

The above disclosure is only the preferred embodiment of the present disclosure, and not used for limiting the scope of the present disclosure. All equivalent variations and modifications on the basis of shapes, structures, features and spirits described in claims of the present disclosure should be included in the claims of the present disclosure.

We claim:

1. A cutter assembly, comprising:
a carrier having a plurality of first holes;
at least one cutter comprising a blade and a cutter seat, wherein the blade is connected to the cutter seat and protrudes upward, the cutter seat comprises at least one upper-adjusting hole and at least one lower-adjusting hole, the at least one upper-adjusting hole and the least one lower-adjusting hole together extend through the cutter seat and have a spatial communication therebetween, and the at least one upper-adjusting hole is formed with a diameter greater than that of the at least one lower-adjusting hole, such that the cutter seat is formed with a countersink surface between the at least one upper-adjusting hole and the at least one lower-adjusting hole;
at least one first fastener having a top portion and a fastening portion connected to each other; and
at least one countersink member connected to the at least one first fastener, wherein a diameter of the at least one countersink member and a diameter of the top portion of the at least one first fastener are less than that of the at least one upper-adjusting hole of the cutter seat, the diameter of the at least one countersink member is greater than that of the at least one lower-adjusting hole of the cutter seat, the fastening portion of the at least one first fastener has a diameter less than that of the at least one lower-adjusting hole, the at least one first fastener passes through the at least one upper-adjusting hole and the at least one lower-adjusting hole of the cutter seat and engages with a corresponding one of the first holes of the carrier to fasten the at least one cutter on the carrier, and the at least one countersink member and the countersink surface of the cutter seat of the at least one cutter have a gap therebetween, thereby the at least one cutter is slightly movable or turnable relative to the carrier during a cutting process.

2. The cutter assembly as claimed in claim 1, further comprising at least one second fastener, wherein the carrier comprises at least one second hole, the cutter seat of the at least one cutter has at least one fastening hole disposed on a lower surface of the cutter seat, and the at least one second fastener passes through the at least one second hole of the carrier and engages with the at least one fastening hole of the cutter seat.

3. The cutter assembly as claimed in claim 1, further comprising at least one lateral fastener, wherein the cutter seat of the at least one cutter has at least one tightening hole disposed on a lateral surface thereof, the blade of the at least one cutter has a through hole, and the at least one lateral fastener passes through the through hole of the blade and engages with the at least one tightening hole to fasten the blade on the cutter seat.

4. The cutter assembly as claimed in claim 1, wherein the least one first fastener is a bolt, the at least one countersink member is a gasket formed with a through hole, the at least one first fastener passes through the through hole of the at least one countersink member and engages with a corresponding one of the first holes of the carrier.

5. The cutter assembly as claimed in claim 1, wherein the carrier is made of wood, the at least one cutter is made of stainless steel, and the blade of at least one cutter is formed as a round-rectangular frame.

6. A cutter assembly, comprising:
a carrier having a plurality of first holes;
at least one cutter comprising a blade and a cutter seat, wherein the blade is connected to the cutter seat and protrudes upward, the cutter seat comprises at least one upper-adjusting hole and at least one lower-adjusting hole, the at least one upper-adjusting hole and the least one lower-adjusting hole together extend through the cutter seat and have a spatial communication therebetween, and the at least one upper-adjusting hole is formed with a diameter greater than that of the at least one lower-adjusting hole, such that the cutter seat is formed with a countersink surface between the at least one upper-adjusting hole and the at least one lower-adjusting hole; and
at least one first fastener having a top portion and a fastening portion connected to each other, the top portion has a diameter which is less than that of the at least one upper-adjusting hole of the cutter seat and which is greater than that of the at least one lower-adjusting hole of the cutter seat, the fastening portion has a diameter less than that of the at least one lower-adjusting hole of the cutter seat, the at least one first fastener passes through the at least one upper-adjusting hole and the at least one lower-adjusting hole of the cutter seat and engages with a corresponding one of the first hole of the carrier to fasten the at least one cutter on the carrier, and the top portion of the at least one first fastener and the countersink surface of the cutter seat of the at least one cutter have a gap therebetween, thereby the at least one cutter is slightly movable or turnable relative to the carrier during a cutting process.

7. The cutter assembly as claimed in claim 6, further comprising at least one second fastener, wherein the carrier comprises at least one second hole, the cutter seat of the at least one cutter has at least one fastening hole disposed on a lower surface thereof, and the at least one second fastener passes through the at least one second hole of the carrier and engages with the at least one fastening hole of the cutter seat.

8. The cutter assembly as claimed in claim 6, further comprising at least one lateral fastener, wherein, the cutter seat of the at least one cutter has at least one tightening hole disposed on a lateral surface thereof, the blade of the at least one cutter has a through hole, and the at least one lateral fastener passes through the through hole of the blade and engages with the at least one tightening hole of the cutter seat to fasten the blade on the cutter seat.

9. The cutter assembly as claimed in claim 6, wherein the carrier is made of wood, the at least one cutter is made of stainless steel, and the blade of the at least one cutter is formed as a round-rectangular frame.

10. A cutting machine, comprising the cutter assembly as claimed in claim 1, and a main console for mounting the cutter assembly.
